(19) United States
(12) Patent Application Publication
(10) Pub. No.: US 2006/0225556 A1
(43) Pub. Date: Oct. 12, 2006

(54) Embedded blade plectrum

(76) Inventor: Peter John Glyde, Burton On Trent (GB)

Correspondence Address: PETER J. GLYDE, MIDWAY, SWADLIN COTE, 471 BURTON RD., BURTON ON TRENT, DE11 7NB, GB

(21) Appl. No.: 11/092,593

(22) Filed: Mar. 29, 2005

(51) Int. Cl. G10D 3/16

(52) U.S. Cl. 84/320

(57) ABSTRACT

The embedded blade plectrum comprises a blade of relatively thick, hard plastic set within a block of relatively soft microcellular polymer material (sponge). It is a general purpose plectrum suitable for all types of acoustic guitar playing. It eliminates having to swap plectra whilst maintaining dynamic control and sound quality and remains in position in the fingers. It is a development of the floating blade plectrum giving increased dynamic control and better tip control. It is simpler in design and construction than the floating blade plectrum.

### CROSS REFERENCE TO RELATED APPLICATIONS

application Ser. No. 10/615,272 Pub. No. US 2004 0031372A1

application Ser. No. 10/645,936

application Ser. No. 10/797,741

GB 0303240.6

GB 0317717.7

GB 0501367.7

### BACKGROUND OF THE INVENTION

This invention relates to an embedded blade plectrum suitable for playing a steel strung acoustic guitar.

### STATEMENT REGARDING FEDERALLY SPONSORED RESEARCH DEVELOPMENT

Not applicable.

### REFERENCE TO SEQUENCE LISTING, A TABLE, OR A COMPUTER PROGRAM LISTING COMPACT DISK APPENDIX.

Not applicable.

### BRIEF SUMMARY OF THE INVENTION

A plectrum is one means of playing the strings of a steel strung acoustic guitar. Typically a plectrum is an egg shaped piece of thin plastic approx. 1″ long by ¾″ wide. It is usually held between the thumb and first finger of the playing hand in a pen-holding grip. There are a number of ways in which the plectrum can be used to play the guitar. The strings can be sounded in rapid succession, i.e. strummed or picked individually, i.e. single note playing. A combination of the two styles of playing is called ‘flat picking’. Conventional plectra are supplied in various thicknesses depending on the style and loudness of playing, e.g. soft strumming, loud strumming, single note playing and flat picking. The disadvantages of using conventional plectra are as follows. Firstly, the player cannot easily change the style of playing, say from soft to loud strumming as this requires putting down one plectrum and picking up the next. Secondly, the sound quality obtained with thin plectra is poor due to high plectrum ‘clatter’ or ‘white noise’ compared to the actual musical notes the instrument is producing. Thirdly, the dynamic control, i.e. the ability to play very loudly and very softly with the same plectrum is poor. Fourthly, conventional plectra are difficult to grip and tend to move and leave the fingers when in use. The embedded blade plectrum is a single general purpose plectrum which eliminates all the listed disadvantages. It is a development of the floating blade plectrum with references as given earlier. The advantages of the embedded blade plectrum over the floating blade plectrum are as follows; improved dynamic range and greater control of the tip of the blade for flat picking and single note playing.

### BRIEF DESCRIPTION OF SEVERAL VIEWS OF THE DRAWING

FIG. 1 shows in perspective the blade 1 set within the block 2 of relatively soft microcellular material.

### DETAILED DESCRIPTION OF THE INVENTION

A conventional plectrum is typically an egg shaped piece of plastic approx. 1″ long by ¾″ wide. The Embedded Blade Plectrum is totally different in operation and construction retaining only a short relatively thick blade of approx. ½″ long by ¾″ wide. It is a development of the Floating Blade Plectrum.

According to the present invention there is provided a blade of relatively thick, hard material mounted within a block of relatively soft microcellular material. The blade is connected to the block using a suitable adhesive.

The plectrum is held in a pen-holding grip between the thumb and first finger. When minimal pressure is applied this allows free movement of the blade. When maximum pressure is exerted the blade is held securely between the finger and the thumb. Varying the grip pressure over the two extremes gives a plectrum of infinitely varying rigidity.

A specific embodiment of the invention will now be described by way of example with reference to the accompanying drawing in which

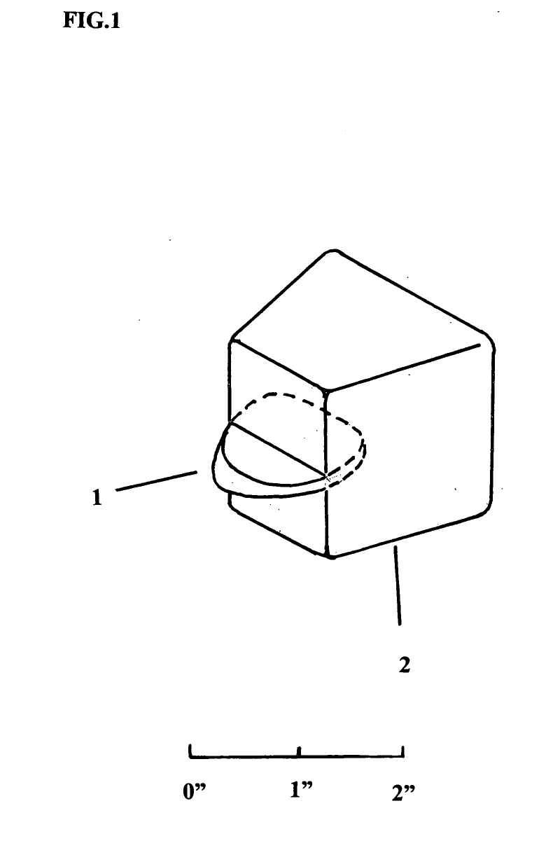

FIG. 1 shows in perspective the blade 1 set within the block 2 of relatively soft microcellular material.

Referring to the drawing the embedded blade plectrum comprises a blade 1 of relatively thick, hard material, e.g. nylon set within a block 2 of relatively soft microcellular material, e.g. natural rubber sponge. The blade 1 is connected to the block 2 via a a slit made within the block 2, a suitable adhesive is then used to connect the blade 1 to the block 2. A suitable adhesive would be a rubber solution based adhesive.

What I claim as my invention is;

1 An embedded blade plectrum comprising a ‘blade’ of relatively thick, hard material set within a block of relatively soft microcellular material.

2 An embedded blade plectrum claimed in claim 1 wherein the blade is made of hard nylon material and the
block is made from a natural rubber based microcellular material.
